(19) United States
(12) Patent Application Publication
(10) Pub. No.: US 2018/0306329 A1
(43) Pub. Date: Oct. 25, 2018

(54) RECIPROCATING EXPANDER VALVE

(71) Applicant: GM GLOBAL TECHNOLOGY OPERATIONS LLC, Detroit, MI (US)

(72) Inventors: Norman K. Bucknor, Troy, MI (US); Stephen B. Glover, County Down (GB); Roy Douglas, County Antrim (GB); Shane M. McKenna, Belfast (GB); Geoffrey McCullough, County Down (GB); Jonathan Patty, Belfast (GB)

(73) Assignee: GM GLOBAL TECHNOLOGY OPERATIONS LLC, Detroit, MI (US)

(21) Appl. No.: 15/771,469

(22) PCT Filed: Dec. 23, 2016
(86) PCT No.: PCT/US2016/068474

§ 371 Date: Apr. 27, 2018

Related U.S. Application Data
(60) Provisional application No. 62/250,598, filed on Nov. 4, 2015.

(51) Int. Cl. F16K 1/36; F01K 23/10

(52) U.S. Cl. CPC F16K 1/36; F01L 3/20; F01K 23/10

(57) ABSTRACT

A pressure balanced valve for an expander of a Rankine cycle heat recovery system includes a valve body that extends along a longitudinal axis. The valve body includes a valve head and an intermediate flange structure spaced apart from each other along the longitudinal axis. The valve body defines an internal flow channel having at least one output port and at least one inlet port. The at least one output port of the internal flow channel is defined by a cylinder chamber side of the valve head. The at least one inlet port of the internal flow channel is defined by a valve stem side of the intermediate flange structure. The internal flow channel is operable to communicate fluid pressure between the cylinder chamber side of the valve head and the valve stem side of the intermediate flange structure.

### CROSS-REFERENCE TO RELATED APPLICATIONS

This application claims the benefit of U.S. Provisional Patent Application Ser. No. 62/250,598, filed on Nov. 4, 2015.

### INTRODUCTION

The disclosure generally relates to a pressure balanced valve for an expander of a Rankine Cycle heat recovery system.

Waste heat recovery systems based on the Rankine cycle utilize heat energy losses that can be converted to work to drive various devices that require input energy. Such systems can be used in automotive and non-automotive systems. For example, in an internal combustion engine of a vehicle, fuel combustion-related energy losses in the form of heat rejected to the exhaust and coolant systems can be partially recovered through a Rankine cycle process using a reciprocating expander such as may be found in steam engines.

In a reciprocating piston expander device, a high-pressure gas from a plenum or other volume is metered into one or more cylinders, each containing a piston connected to a drive mechanism. The gas expands in volume as it does the work of driving the piston(s) to produce mechanical work via the drive mechanism. This metering is accomplished via one or more intake valve(s) which intermittently connect each cylinder with the source of high-pressure gas. During the times when the intake valve is closed, it is acted upon by the high-pressure gas in the plenum, which tends to force the valve toward its open position. It is therefore desirable to counteract this gas pressure and maintain the valve in its closed state with minimal external force. A pressure-balanced valve achieves this objective by reducing or cancelling out the pressure-based forces acting on it.

Caprotti pressure-balanced valves are well-known versions of double-poppet valves. Such valves have been used in steam engines as an alternative to a sleeve valve. An important design feature is that the valve has two seats, which must be engaged simultaneously to maintain the integrity of the pressure cylinder with which the valve communicates. This requires that features of the valve seat cage must account for thermal expansion. As a result, imprecision in the manufacture of these valves makes it difficult to have both valve seats perfectly sealed.

### SUMMARY

A valve for an expander of a Rankine cycle heat recovery system is provided. The valve includes a valve body that extends along a longitudinal axis. The valve body includes a valve head and an intermediate flange structure spaced apart from each other along the longitudinal axis. The valve body defines an internal flow channel having at least one output port and at least one inlet port. The at least one output port of the internal flow channel is defined by the valve head. The at least one inlet port of the internal flow channel is defined by the intermediate flange structure. The internal flow channel is operable to communicate fluid pressure between a chamber side of the valve head and a valve stem side of the intermediate flange structure.

In one aspect of the valve, the valve head includes a neck portion that is disposed on an inlet side of the valve head. The inlet side is opposite the chamber side of the valve head. The neck portion of the valve head presents a projected surface area perpendicular to the longitudinal axis having a first area. The intermediate flange structure includes an inlet side, which is disposed opposite the stem side of the intermediate flange structure. The inlet side of the intermediate flange structure presents a projected surface area perpendicular to the longitudinal axis having a second area. The first area and the second area substantially equal to each other.

In another aspect of the valve, the valve stem side of the intermediate flange structure presents a projected surface area perpendicular to the longitudinal axis having a third area. The chamber side of the valve head presents a projected surface area perpendicular to the longitudinal axis having a fourth area. The fourth area is greater than the third area.

In one embodiment of the valve, the intermediate flange structure includes a first protruding flange and a second protruding flange. The intermediate flange structure includes an annular recessed area disposed axially along the longitudinal axis, between the first protruding flange and the second protruding flange. A seal is positioned within the annular recess area.

In one aspect of the valve, the at least one inlet port includes a plurality of inlet ports, which are arranged annularly around the longitudinal axis. In one embodiment of the valve, the intermediate flange structure includes a neck portion disposed on the valve stem side of the intermediate flange structure, with the plurality of inlet ports defined by the neck portion.

An expander for a Rankine cycle heat recovery system is also provided. The expander includes a cylinder head having a valve bore extending long a longitudinal axis. The valve bore presents a valve opening into a cylinder chamber. The cylinder head further defines an inlet port in fluid communication with the valve bore. A valve is disposed within the valve bore. The valve is moveable along the longitudinal axis between an open position and a closed position. When the valve disposed in the open position, the valve opens fluid communication between the inlet port and the cylinder chamber. When the valve is disposed in the closed position, the valve blocks fluid communication between the inlet port and the cylinder chamber. The valve includes a valve body that extends along the longitudinal axis. The valve body includes a valve head and an intermediate flange structure spaced apart from each other along the longitudinal axis. The valve body defines an internal flow channel having at least one output port and at least one inlet port. The at least one output port is defined by the valve head. The at least one inlet port is defined by the intermediate flange structure. The internal flow channel is operable to communicate fluid pressure between the cylinder chamber and a portion of the valve bore disposed on a valve stem side of the intermediate flange structure.

In one aspect of the expander, the valve head includes a neck portion disposed on an inlet side of the valve head. The inlet side of the valve head is disposed opposite the cylinder chamber side of the valve head. The neck portion of the valve head presents a projected surface area perpendicular to the longitudinal axis having a first area. The intermediate flange structure includes an inlet side, which is disposed opposite the valve stem side of the intermediate flange structure. The inlet side of the intermediate flange structure presents a projected surface area perpendicular to the longitudinal axis having a second area. The first area and the second area are substantially equal to each other. In another aspect of the expander, the valve stem side of the intermediate flange structure presents a projected surface area perpendicular to the longitudinal axis having a third area. The chamber cylinder side of the valve head presents a projected surface area perpendicular to the longitudinal axis having a fourth area. The fourth area is greater than the third area.

In one embodiment of the expander, the intermediate flange structure includes a first protruding flange and a second protruding flange. An annular recessed area is disposed axially along the longitudinal axis between the first protruding flange and the second protruding flange. The valve further includes a seal positioned within the annular recess area. The seal is operable to seal against the valve bore.

In another aspect of the expander, the at least one inlet port includes a plurality of inlet ports arranged annularly around the longitudinal axis.

Accordingly, the valve includes surface features and the internal flow channel so that net gas-generated forces acting on the valve are reduced, which allows a cam drive to operate the valve more easily. The lower opening forces of the valve, compared to those of a conventional poppet valve, are provided by a more pressure balanced valve. The respective design reduces the return spring force that is otherwise required by conventional poppet valves. Other advantages of the valve design described herein are that the valve is easier to manufacture in comparison to a double-seat pressurize balanced valve, and also sealing of the valve described herein is more robust that a one-valve seat. This respective design enables the use of a reciprocating expander that can improve the efficiency of a Rankine Cycle waste heat recovery system, leading to increased fuel economy for automotive applications.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic plan view of a Rankine cycle heat recovery system.

FIG. 2 is a schematic partially cross sectioned side view of a pressure balanced valve in a closed position.

FIG. 3 is a schematic perspective view from above of the pressure balanced valve.

FIG. 4 is a schematic cut-away perspective view from above of the pressure balanced valve.

FIG. 5 is a schematic perspective view from below of the pressure balanced valve.

FIG. 6 is a schematic partially cross sectioned view of the pressure balanced valve in an open position.

FIG. 7 is a schematic partially cross sectioned view of a second embodiment of the pressure balanced valve in the closed position.

FIG. 8 is a schematic perspective view from below of the second embodiment of the pressure balanced valve.

FIG. 9 is a schematic partially cross sectioned view of the pressure balanced valve in the open position.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

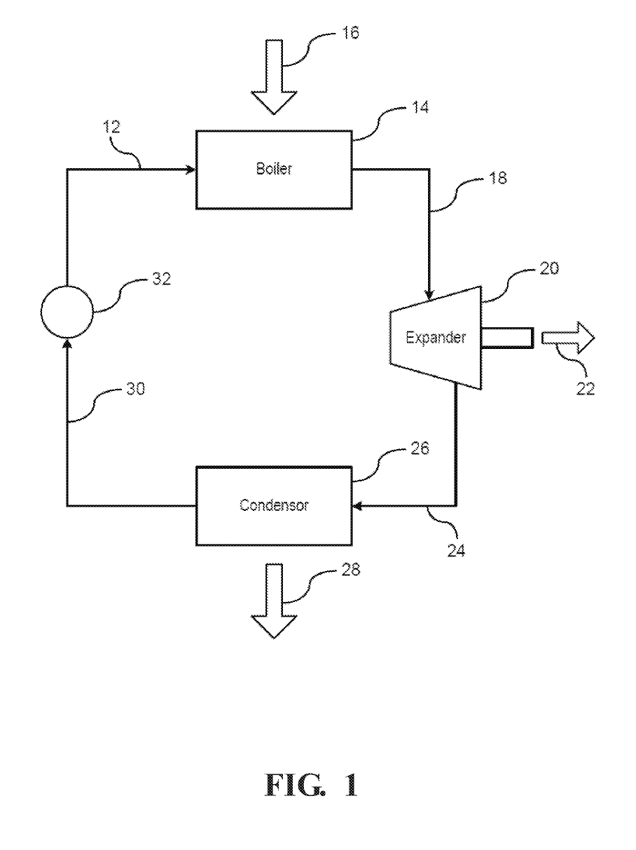

Referring to the FIGS., wherein like numerals indicate like parts throughout the several views, a heat recovery system is generally shown at 10 in FIG. 1. Referring to FIG. 1, heat recovery systems utilize energy that would typically be exhausted into the environment and wasted. A Rankine cycle heat recovery system utilizes heat from a heat exhaust system to convert the exhaust heat into input energy that is used to generate work to drive a respective device. A typical Rankine Cycle is a thermodynamic cycle that uses a fluid and or steam/vapor. Rankine cycle-type systems vaporize a pressurized fluid. The pressurized fluid is then heated by the exhaust gases, and the fluid is turned into steam/vapor. The steam is then introduced via one or more intake valves to a reciprocating expander. The pressurized gas expands in the chamber of the expander machine and will drive a reciprocating piston or similar in the expander to generate the work. The expander can be directly coupled to a device to perform work such a crankshaft, alternator, or other device.

Such systems utilizing Rankine cycle engines can be automotive or non-automotive systems. The fluid in such engines can be any substance that has liquid and gas phases based on the operating temperature and pressures of the system. Common fluids include water and organic (carbon-based) fluids such as refrigerants. In automotive systems, the recovery of waste heat from the combustion cycle can provide fuel economy advantages, as well as reducing vehicle CO₂ emissions. Such systems can be used in conventional gas or diesel applications as well as hybrid systems. In addition, energy produced can be electrical energy which can be recaptured in batteries or mechanical energy introduced on the crankshaft.

FIG. 1 illustrates an exemplary overview of a Rankine cycle system. At an initial stage, a low temperature, high pressure fluid 12 is provided to a boiler 14. Waste heat 16, recaptured by an exhaust system (e.g., exhaust system of a vehicle) or non-automotive system is provided to the boiler 14. The waste heat 16 provided to the boiler 14 converts the low temperature, high pressurized fluid 12 into a high pressure, high temperature gas 18 and is output from the boiler 14. The high pressure, high temperature gas 18 is input to an expander 20 (e.g., reciprocating piston expander). The high pressure, high temperature gas 18 is provided to an expansion chamber via valves where the gas 18 is allowed to expand and act on a reciprocating piston within the expander 20. The expander 20 generates mechanical output work 22. It should be understood that the embodiments described herein can be used in automotive or non-automotive systems.

The gas 18 expanded within expander 20 is allowed to expand resulting in low pressure, low temperature gas 24 exiting the expander 20. The low pressure, low temperature gas 24 is input to a condenser 26 where heat 28 is extracted from the low pressure, low temperature gas 24 and is output to the environment.

As the low pressure, low temperature gas 24 is allowed to cool, the gas converts to a low pressure, low temperature fluid 30. The low pressure, low temperature fluid 30 is input to a pump 32. The pump 32 converts the low pressure, low temperature fluid 30 into the high pressure, low temperature fluid 12. The pump uses relatively little input energy compared to the expander work output.

As described earlier, due to the high pressure generated by the boiler, high pressurized gas acts on the valves of the expander 20. A cam acts on each of the valve stems of the valves for opening and closing the valves at respective time intervals for allowing pressurized gas to enter and exit the expander. Due to the high pressure of the fluid entering an expander chamber, a large amount of force is exerted on a bottom surface of the head. When using a non-pressure balanced valve, a critical issue is that it requires a very high return spring force to seal against pressure in an intake port. This makes it difficult to open via cam actuation. Various types of valve have deficiencies such as sleeve valves having leakage issues, and double-seated valve requiring precise manufactured valve seats to seal properly as well as specialized valve seat cages to account for thermal expansion. The embodiments described herein overcome the deficiencies with non-pressure balanced valves and double seated valves.

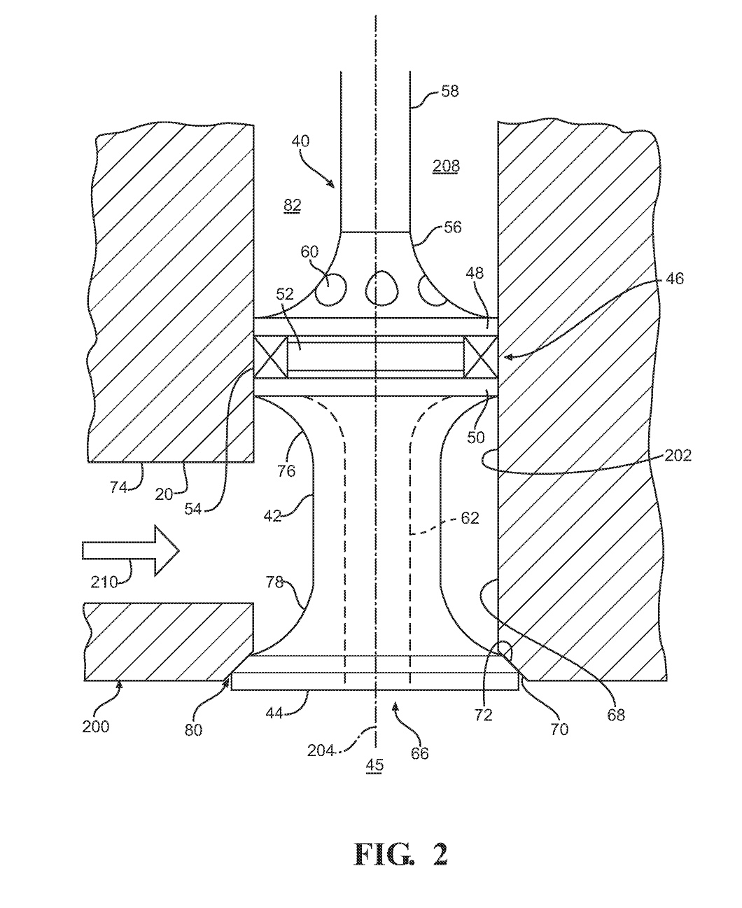

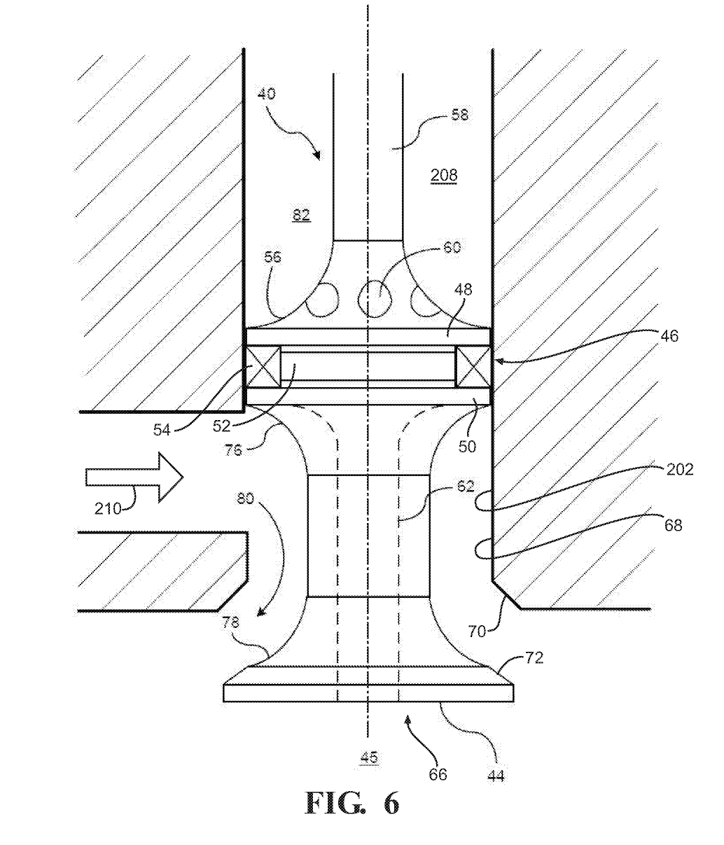

Referring to FIG. 2, the expander 20 includes a cylinder head 200 having a valve bore 202 extending long a longitudinal axis 204. The valve bore 202 presents a valve opening 66 to a cylinder chamber 45. The cylinder head 200 further includes or defines an inlet port 74 in fluid communication with the valve bore 202. A pressure balanced valve 40 is disposed within the valve bore 202. The pressure balanced valve 40 is moveable, within the valve bore 202, along the longitudinal axis 204, between an open position, shown in FIG. 6, and a closed position, shown in FIG. 2. When the pressure balanced valve 40 is disposed in the open position, the pressure balanced valve 40 opens or allows fluid communication between the inlet port 74 and the cylinder chamber 45. When the pressure balanced valve 40 is disposed in the closed position, the pressure balanced valve 40 closes or blocks fluid communication between the inlet port 74 and the cylinder chamber 45.

Referring to FIG. 2, the pressure balanced valve 40 includes a valve body 42, which extends along the longitudinal axis 204. The valve body 42 includes a valve head 44 and an intermediate flange structure 46 that are spaced apart from each other along the longitudinal axis 204. The valve body 42 typically includes a hardened surface at a distal end from the head 44 for contacting a cam. The cam typically includes a lobed cam that exerts a force for driving the pressure balanced valve 40 into a cylinder chamber 45 of an expander 20 for allowing pressurized gas to enter the cylinder chamber 45. The intermediate flange structure 46 includes two protruding flange disks 48 and 50 that are integral to the valve body 42. A recessed area 52 is disposed between the first flange disk 48 and the second flange disk 50. A seal 54 is disposed in the recessed area 52 for sealing against a cylinder wall 68 of the valve bore 202.

The valve body 42 defines an internal flow channel 62 having at least one output port 64 defined by the valve head 44, and at least one inlet port 60 defined by the intermediate flange structure 46. The internal flow channel 62 is operable to communicate fluid pressure between the cylinder chamber 45 and a portion of the valve bore 202 disposed on a valve stem side 208 of the intermediate flange structure 46.

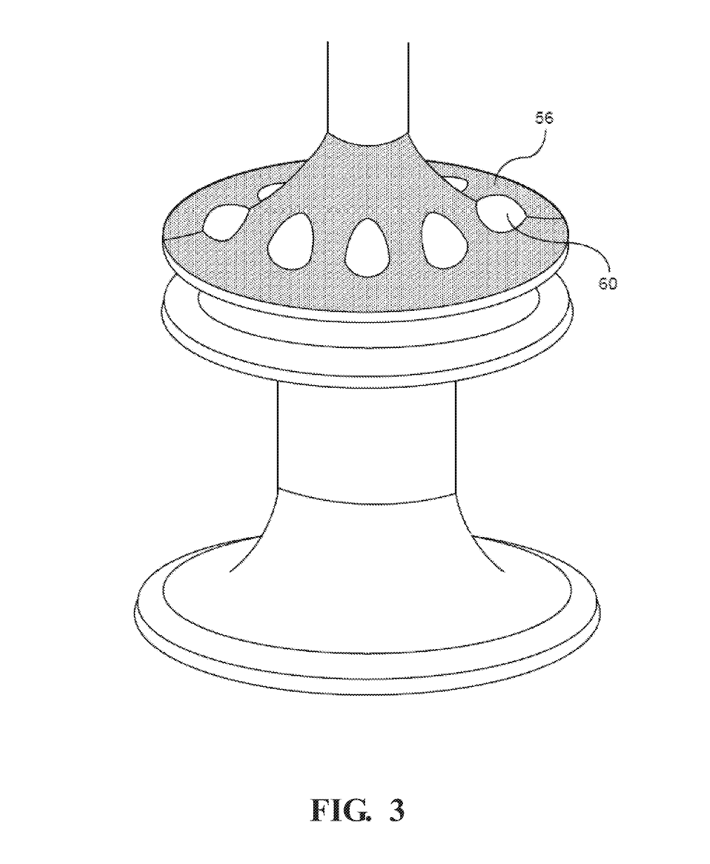

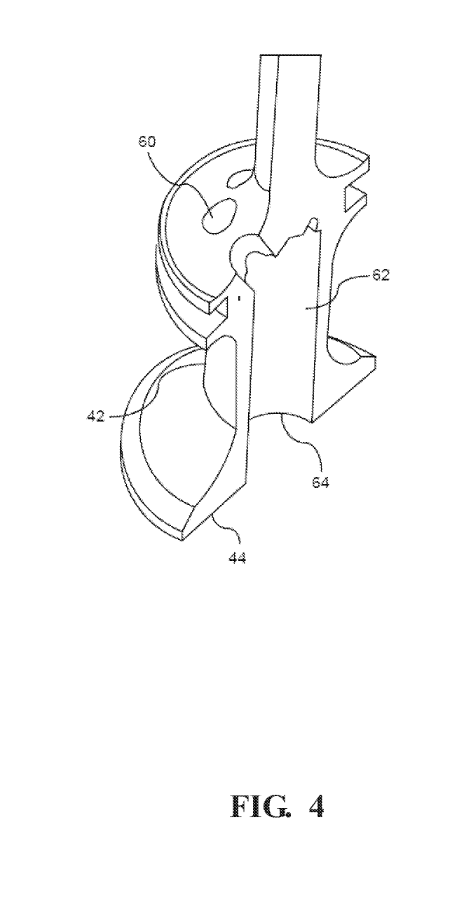

The first flange disk 48 includes a neck portion 56 that integrally connects the first flange disk 48 to a valve stem 58. The neck portion 56 is disposed on the valve stem side 208 of the intermediate flange structure 46. The neck portion 56 includes a plurality of input ports 60 disposed circumferentially around the neck portion 56. The input ports 60 disposed circumferentially around the neck portion 56 are illustrated in detail in the perspective view of FIG. 3. Referring again to FIG. 2, the input ports 60 are in fluid communication with the internal flow channel 62 disposed centrally within the valve body 42. The internal flow channel 62 extends longitudinally within the valve body 42, along the longitudinal axis 204, from the input ports 60 to the valve head 44. A cut away view of the valve body 42 illustrating the internal flow channel 62 being in communication with the plurality of input parts 60 is shown in FIG. 4. As shown in FIG. 4, the input ports 60 allow fluid communication of gas entering the input ports 60 to flow through the internal flow channel 62 to an output port 64 formed in the head 44 when the valve closes and in the opposite direction when the valve opens.

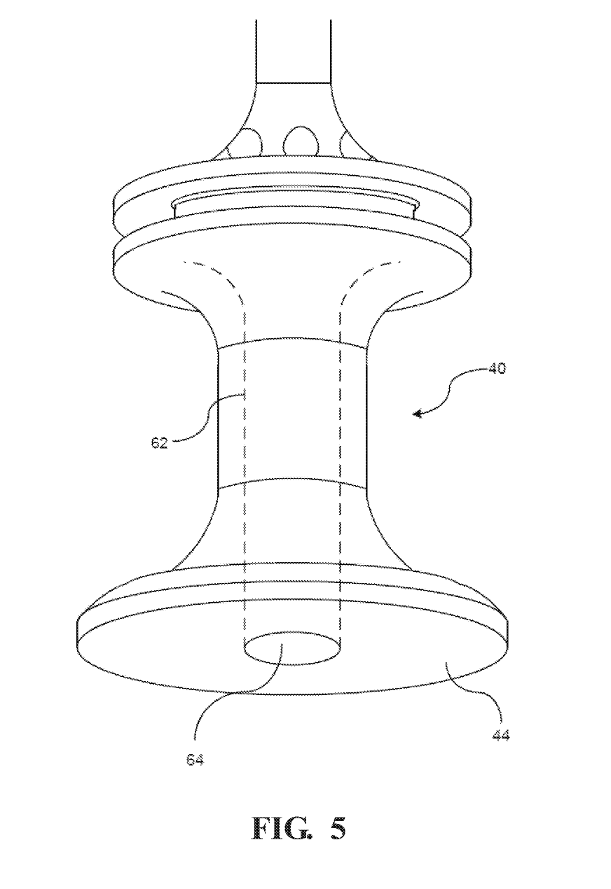

FIG. 5 illustrates a perspective view of the valve 40 showing a bottom surface of the head 44 of the valve 40 with the output port 64 formed through the bottom surface of the head 44 that allows for fluid communication of the gas from the internal flow channel 62 to the cylinder chamber 45.

Referring again to FIG. 2, the head 44 is mushroom-shaped for seating in a valve opening 66 formed in a cylinder wall 68 of the expander 20. The cylinder wall 68 includes chamfered surface 70 that mates with a chamfered surface 72 of the head 44 for sealing and preventing plenum pressurized gas entering the valve port 74 from entering the cylinder chamber 45 of the expander 20.

The valve head 44 includes a neck portion 78 that is disposed on an inlet side of the valve head 44. The inlet side of the valve head 44 is the side of the valve head 44 closest to the inlet port 74, and is disposed opposite a chamber side of the valve head 44. The chamber side of the valve head 44 is disposed on a side of the valve head disposed immediately adjacent or facing the cylinder chamber 45. The neck portion 78 of the valve head 44 presents a projected surface area perpendicular to the longitudinal axis 204 having a first area. As used herein, the projected surface area is the area of a surface projected onto a plane that is orthogonal to the longitudinal axis 204. It should be appreciated that because the neck portion 78 includes a frustoconical shape, it has an actual surface area that is larger than its projected surface area. However, it should also be appreciated that the projected surface area is the portion of the actual surface area that may be acted upon to move the valve 40 axially along the longitudinal axis 204.

The intermediate flange structure includes an inlet side, which is opposite the stem side of the intermediate flange structure. The intermediate flange structure includes a neck portion 76 of the second protruding flange, which is disposed in the inlet side of the intermediate flange structure. The neck portion 76 of the second protruding flange on the inlet side of the intermediate flange structure presents a projected surface area perpendicular to the longitudinal axis having a second area. The first area and the second area being substantially equal with each other. Accordingly, when the valve 40 is in the closed position as illustrated in FIG. 2, plenum pressurized gases entering valve port 74 exert an equal pressure on the neck portion 76 of the second flange disk 50 and the neck portion 78 of the head 42. The equal pressure exerted on neck portion 76 and neck portion 78 provides a balanced force along the longitudinal axis 204 acting on the valve body 42, for preventing movement of the valve 40 along the longitudinal axis 204.

The neck portion 56 of the first protruding flange 48 on the valve stem side 208 of the intermediate flange structure 46 also presents a projected surface area perpendicular to the longitudinal axis 204 having a third area. The chamber side of the valve head 44 presents a projected surface area perpendicular to the longitudinal axis 204 having a fourth area. The fourth area is greater than the third area, such that equal fluid pressures acting on the third area of the neck portion 56 and the fourth area of the face of the valve head 44 generate a differential axial force acting on the valve body 42 along the longitudinal axis 204.

FIG. 6 illustrates a position of the valve 40 relative to the cylinder chamber 45, when the cam exerts a force on the valve 40 for opening a flow channel of pressurized gas to the cylinder chamber 45. When the cam exerts a force on the valve stem 58 to displace the valve in a longitudinal direction so that the head 44 is moved into the cylinder chamber 45, the plenum pressurized gas 210 flows into the cylinder chamber 45 through the flow input port 74 generally represented by arrow 80. The cylinder chamber 45 is initially pressurized at atmospheric pressure. As pressurized gas fills and expands the cylinder chamber 45 to exert a force on the reciprocating piston therein, the pressurized gas in the cylinder chamber also increases and exerts a force on the bottom surface of the head 44, i.e., the fourth area. The pressure exerted on the head of a conventional solid poppet valve would tend to produce a large resistive force on the cam via the valve. In the valve shown in FIG. 6, the internal flow channel 62 overcomes the deficiencies of the back pressure in the cylinder chamber acting on the head 44. As described earlier, when the cam moves the valve downward to an open position, pressurized gas is allowed to enter the cylinder chamber 45 through the intake port 74. As the pressurized gas expands and fills the cylinder chamber 45, some of the pressurized gas flows up through the internal flow channel 62 and through ports 60 to fill an upper chamber 82, i.e., the portion of the valve bore 202 disposed on the valve stem side 208 of the intermediate flange structure 46, until the pressure is equalized everywhere. At this point in time, the pressure acting on valve surfaces of portions 44, 56, 76, and 78 are equalized. When the cylinder pressure is substantially equalized with the pressure entering the valve, the net force acting on the valve is reduced due to the equalization as a result of the pressurized gas that is allowed to flow up through the internal flow channel 62 to chamber 82. As a result, net forces are reduced which allows the cam to operate the valve more easily with lower opening forces of the valve which results in a more pressure balanced valve in contrast to a conventional poppet valve. While the pressure exerted on valve surfaces 44 and 56 are not exactly equal, the difference results in a low net upward force on the valve 40. This has the benefit of maintaining positive contact between the valve stem 58 and the cam thereby enabling reduction in stiffness of a valve return spring. The cam drive is able to overcome this force in operating the valve opening and closing according to the cam profile. The respective design reduces the return spring force that is otherwise required by conventional poppet valves. Other advantages of the valve design described herein are that the valve 40 is easier to manufacture in comparison to a double-seat pressurized balanced valve, and also sealing of the valve 40 described herein is more robust that a one-valve seat. This respective design also increases waste heat recovery by enabling a more efficient expander design, which can lead to increased fuel economy for automotive applications.

The projected areas in the longitudinal direction of the surfaces 76 and 78, i.e., the first area and the second area, are equal and serve to cancel the gas pressure tending to open the valve, allowing the valve to be pressure-balanced when closed. An ordinary valve return spring is therefore sufficient to keep the valve closed. When the valve is open, the projected areas of surfaces 44 and 56, i.e., the third area and the fourth area respectively, are almost equal such that only a small upward force is exerted on the valve by the gas pressure acting on all surfaces of the valve.

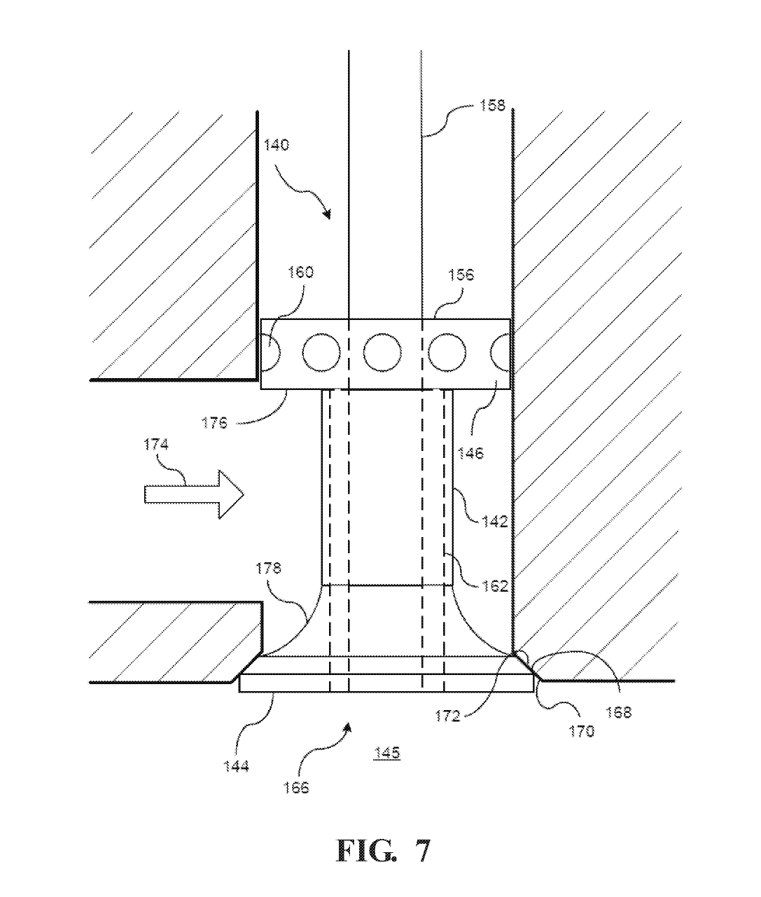

FIG. 7 illustrates a second embodiment of the valve. A valve 140 includes a valve body 142 and valve head 144. The valve body 142 includes a flange structure 146 that is integral to the valve body 142. The flange structure has a diameter that is larger than the diameter of the valve body 142. The flange structure 146 includes a plurality of input ports 160 disposed circumferentially on a circumferential wall of the flange structure 146.

The head 144 is mushroom-shaped for seating in a valve opening 166 formed in a cylinder wall 168 of the expander 20. The cylinder wall 168 includes chamfered surface 170 that mates with a chamfered surface 172 in valve 140 for sealing pressurized gas entering a valve port 174 and gas within the cylinder chamber 145 of the expander 20. When the valve 140 is in a closed position as illustrated in FIG. 7, pressurized gas entering valve port 174 exerts an equal pressure on a neck portion 176 of the flange structure 146 and a neck portion 178 of the head 144. The equal pressure exerted on neck portion 176 and neck portion 178 provides a balanced force acting on the valve body 142.

The valve 140 includes a valve stem 158 disposed centrally through the valve 140. The valve stem 158 extends from a top of the valve 140 for making contact with the cam to the bottom surface of the head 144.

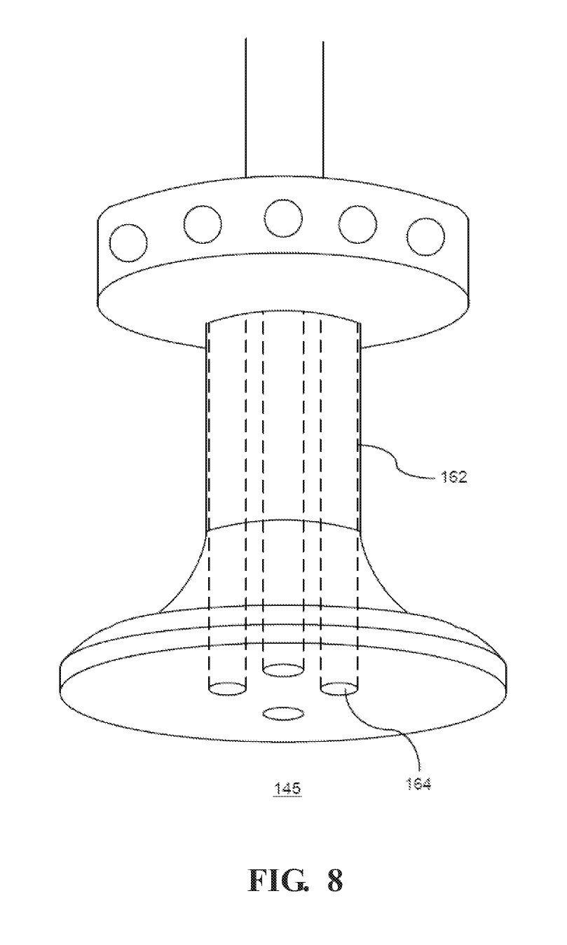

A plurality of flow channels 162 extend longitudinally within the valve body 142 and are radially disposed around the valve stem 158. Each of the flow channels 162 is parallel to the valve stem 158. The input ports 160 are in fluid communication with the plurality of flow channels 162 for allowing pressurized gas to flow from the input ports 160 when input ports are in fluid communication with the intake port 174. When in the closed position, the input ports 160 are not in fluid communication with the intake port 174, and as a result, no pressurized gas flows to the flow channels 162 via the input ports 160. FIG. 8 illustrates a perspective view of the valve 140 illustrating the output ports 164 which allow communication of pressurized gas from the internal flow channels 162 to the cylinder chamber 145.

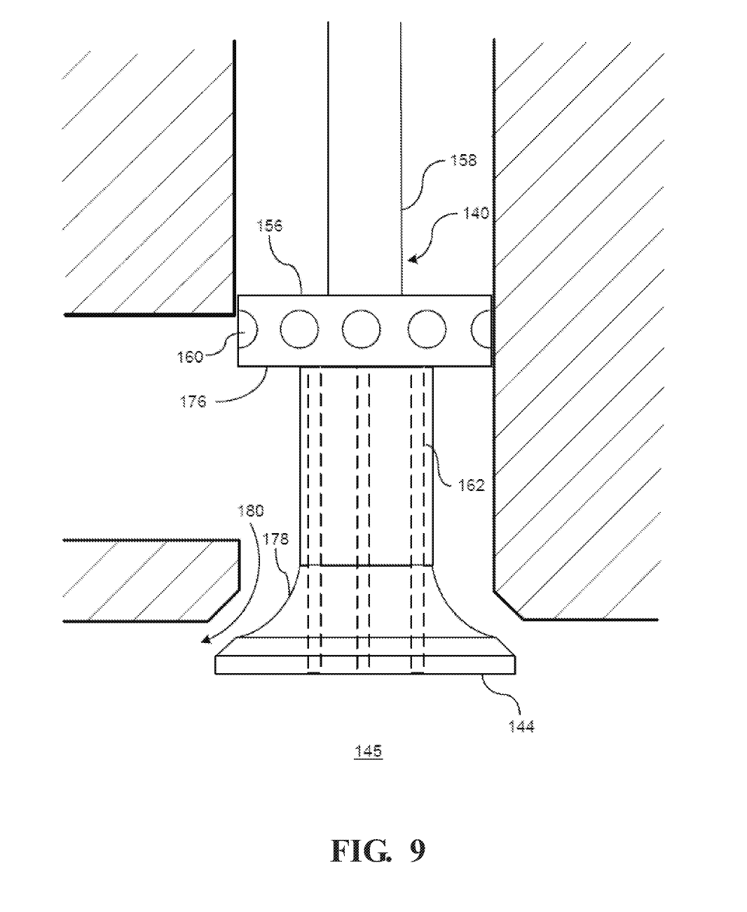

FIG. 9 illustrates the valve 140 in an open position as shown by the position of the valve 140 relative to the cylinder chamber 145 when the cam exerts a force on the valve stem 158 for opening a flow channel of pressurized gas to the cylinder chamber 145. When the cam moves the valve downward to an open position, pressurized gas is allowed to enter the cylinder chamber 145 via the intake port 180, the aperture ports 160, and internal flow channels 162. The ports 160 improve the total flow area of the valve when it is open. Once the pressurized gas expands and fills the cylinder chamber 145, the pressurized gas acting on a bottom of the head 144 is allowed to exert a reverse force on the pressurized gas flowing through internal flow channels 162. When the cylinder pressure is substantially equalized with the pressure from the intake port 180, the net force acting on the valve is reduced due to the pressure that is allowed to flow in a reverse direction through the internal flow channels 162. As described earlier, net forces are reduced which allows the cam to operate the valve more easily with lower opening forces of the valve resulting in a more pressure balanced valve in contrast to a conventional poppet valve.

The projected areas in the longitudinal direction of surfaces 176 and 178 cancel the gas pressure force acting on the valve in the longitudinal direction when the valve is closed. When the valve is open, the projected areas of surface 144 and surface 156 are almost equal, canceling out the additional forces imparted to the valve when these surfaces are in communication with the high pressure gas.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A valve for an expander of a Rankine cycle heat recovery system, the valve comprising:
a valve body extending along a longitudinal axis and having a valve head and an intermediate flange structure spaced apart from each other along the longitudinal axis;
wherein the valve body defines an internal flow channel having at least one output port defined by the valve head and at least one inlet port defined by the intermediate flange structure, with the internal flow channel operable to communicate fluid pressure between a chamber side of the valve head and a valve stem side of the intermediate flange structure.

2. The valve set forth in claim 1, wherein the valve head includes a neck portion disposed on an inlet side of the valve head, opposite the chamber side of the valve head, wherein the neck portion of the valve head presents a projected surface area perpendicular to the longitudinal axis having a first area.

3. The valve set forth in claim 2, wherein the intermediate flange structure includes an inlet side, opposite the stem side of the intermediate flange structure, wherein the inlet side of the intermediate flange structure presents a projected surface area perpendicular to the longitudinal axis having a second area, with the first area and the second area being substantially equal with each other.

4. The valve set forth in claim 3, wherein the valve stem side of the intermediate flange structure presents a projected surface area perpendicular to the longitudinal axis having a third area.

5. The valve set forth in claim 4, wherein the chamber side of the valve head presents a projected surface area perpendicular to the longitudinal axis having a fourth area, with the fourth area being greater than the third area.

6. The valve set forth in claim 1, wherein the intermediate flange structure includes a first protruding flange and a second protruding flange.

7. The valve set forth in claim 6, wherein the intermediate flange structure includes an annular recessed area disposed axially along the longitudinal axis between the first protruding flange and the second protruding flange.

8. The valve set forth in claim 7, further comprising a seal positioned within the annular recess area.

9. The valve set forth in claim 1, wherein the at least one inlet port includes a plurality of inlet ports.

10. The valve set forth in claim 9, wherein the plurality of inlet ports are arranged annularly around the longitudinal axis.

11. The valve set forth in claim 10, wherein the intermediate flange structure includes a neck portion disposed on the valve stem side of the intermediate flange structure.

12. The valve set forth in claim 11, wherein the plurality of inlet ports are defined by the neck portion disposed on the valve stem side of the intermediate flange structure.

13. An expander for a Rankine cycle heat recovery system, the expander comprising:
a cylinder head having a valve bore extending long a longitudinal axis and presenting a valve opening to a cylinder chamber, and an inlet port in fluid communication with the valve bore;
a valve disposed within the valve bore and moveable along the longitudinal axis between an open position opening fluid communication between the inlet port and the cylinder chamber, and a closed position blocking fluid communication between the inlet port and the cylinder chamber, the valve including:
a valve body extending along the longitudinal axis and having a valve head and an intermediate flange structure spaced apart from each other along the longitudinal axis;
wherein the valve body defines an internal flow channel having at least one output port defined by the valve head and at least one inlet port defined by the intermediate flange structure, with the internal flow channel operable to communicate fluid pressure between the cylinder chamber and a portion of the valve bore disposed on a valve stem side of the intermediate flange structure.

14. The expander set forth in claim 13, wherein the valve head includes a neck portion disposed on an inlet side of the valve head, opposite the cylinder chamber side of the valve head, wherein the neck portion of the valve head presents a projected surface area perpendicular to the longitudinal axis having a first area.

15. The expander set forth in claim 14, wherein the intermediate flange structure includes an inlet side, disposed opposite the valve stem side of the intermediate flange structure, wherein the inlet side of the intermediate flange structure presents a projected surface area perpendicular to the longitudinal axis having a second area, with the first area and the second area being substantially equal with each other.

16. The expander set forth in claim 15, wherein the valve stem side of the intermediate flange structure presents a projected surface area perpendicular to the longitudinal axis having a third area.

17. The expander set forth in claim 16, wherein the chamber cylinder side of the valve head presents a projected surface area perpendicular to the longitudinal axis having a fourth area, with the fourth area being greater than the third area.

18. The expander set forth in claim 13, wherein the intermediate flange structure includes a first protruding flange and a second protruding flange, and defines an annular recessed area disposed axially along the longitudinal axis between the first protruding flange and the second protruding flange.

19. The expander set forth in claim 18, wherein the valve further includes a seal positioned within the annular recess area, and operable to seal against the valve bore.

20. The expander set forth in claim 13, wherein the at least one inlet port includes a plurality of inlet ports arranged annularly around the longitudinal axis.
